(19) United States
(12) Patent Application Publication
(10) Pub. No.: US 2019/0199897 A1
(43) Pub. Date: Jun. 27, 2019

(54) IMAGE CAPTURING APPARATUS

(71) Applicant: CANON KABUSHIKI KAISHA, Tokyo (JP)

(72) Inventor: Kazuhiko Momoki, Koshigaya-shi (JP)

(21) Appl. No.: 16/225,728

(22) Filed: Dec. 19, 2018

(30) Foreign Application Priority Data
Dec. 26, 2017 (JP) 2017-250268

(51) Int. Cl. H04N 5/225; G06T 7/70; H04N 13/243

(52) U.S. Cl. CPC H04N 5/2258; H04N 5/2253; H04N 13/243; G06T 7/70; H04N 5/2254

(57) ABSTRACT

An image capturing apparatus includes first, second, third, and fourth image capturers. A protector is a portion projecting to an object side from a vertex of an optical surface closest to the object side of each of the two optical systems in the optical system between visual fields of the two image capturers among the first to fourth image capturers and is provided between visual fields of the first and third image capturers, between visual fields of the third and second image capturers, between visual fields of the second and fourth image capturers, and between visual fields of the first and fourth image capturer, and no protector is provided between the visual fields of the first and second image capturers and between the visual fields of the third and fourth image capturers.

### BACKGROUND OF THE INVENTION

### Field of the Invention

The present invention relates to an image capturing apparatus (or imaging apparatus) configured to capture an image in all directions (or azimuths) using a plurality of cameras.

### Description of the Related Art

Japanese Patent Laid-open No. (“JP”) 2016-118742 discloses an image capturing apparatus capable of capturing an image in all directions including horizontal 360° around it and positions directly above and below from the position of the image capturing apparatus, or an omnidirectional image. This image capturing apparatus includes two fisheye lenses facing sides opposite to each other, combines two images obtained through imaging with these two cameras, and generates an omnidirectional image. U.S. Pat. No. 8,902,322 discloses an image capturing apparatus that includes four cameras facing four vertices of a regular tetrahedron surrounding these cameras, combine four images captured by these four cameras with one another, and generates an omnidirectional image.

The image capturing apparatus disclosed in JP 2016-118742 exposes lens surfaces closest to the object in the fisheye lenses at both sides. Therefore, when the image capturing apparatus falls down and the lens surface of one of the fisheye lenses collide with the ground, the lens surface gets scratched. On the other hand, the image capturing apparatus disclosed in U.S. Pat. No. 8,902,322 arranges the lens surface vertices of the respective cameras deeper than a mechanical member as part of the image capturing apparatus and the lens surface is unlikely to contact the ground. However, the lens surface may get damaged by any convex portions, such as pebbles, on the ground.

### SUMMARY OF THE INVENTION

The present invention provides an omnidirectional image capturing apparatus that is less likely to get scratched on a lens surface.

An image capturing apparatus according to one aspect of the present invention includes first, second, third, and fourth image capturers each including an optical system and an image sensor having a rectangular image capturing surface orthogonal to an optical axis in the optical system. First and second optical axes in the first and second image capturers are line-symmetrical with respect to a reference axis in a first plane, and a short side direction of the image capturing surface in each of the first and second image capturers is orthogonal to the first plane. Third and fourth optical axes in the third and fourth image capturers are line-symmetric with respect to the reference axis in a second plane orthogonal to the first plane, and a short side direction of the image capturing surface of each of the third and fourth image capturers is orthogonal to the second plane. The first and second optical axes incline to a third plane orthogonal to the reference axis on one side of the third plane. The third and fourth optical axes incline to the third plane on the other side of the third plane. A protector is a portion projecting to an object side from a vertex of an optical surface closest to the object side of each of the two optical systems between visual fields of the two image capturers among the first to fourth image capturers. The protector is provided between visual fields of the first and third image capturers, between visual fields of the third and second image capturers, between visual fields of the second and fourth image capturers, and between visual fields of the first and fourth image capturer. No protector is provided between the visual fields of the first and second image capturers and between the visual fields of the third and fourth image capturers.

Further features of the present invention will become apparent from the following description of exemplary embodiments with reference to the attached drawings.

### BRIEF DESCRIPTION OF THE DRAWINGS

FIG. 1 is an external perspective view of an omnidirectional image capturing apparatus according to a first embodiment of the present invention when viewed from an upper oblique direction.

FIGS. 2A to 2D are a top view, a bottom view, a front view, and a side view of the image capturing apparatus according to the first embodiment.

FIG. 3 is an external perspective view of the image capturing apparatus according to the first embodiment when viewed from a lower oblique direction.

FIG. 4 illustrates a configuration of a camera used in the image capturing apparatus according to the first embodiment.

FIGS. 5A and 5B illustrate an arrangement of four cameras in the image capturing apparatus according to the first embodiment.

FIGS. 6A to 6C illustrate directions and arrangement of the optical axes in the four cameras in the image capturing apparatus according to the first embodiment.

FIG. 7 is a spherical view illustrating all directions of the optical axes in the four cameras in the image capturing apparatus according to the first embodiment.

FIGS. 8A to 8C illustrate a solid angle range imaged on image sensors in the four cameras in the image capturing apparatus according to the first embodiment.

FIGS. 9A to 9C illustrate a relationship among visual fields of four cameras in the image capturing apparatus according to the first embodiment.

FIGS. 10A and 10B illustrate view angle allocations on an equatorial plane and a meridional direction of four cameras in the image capturing apparatus according to the first embodiment.

FIGS. 11A to 11C illustrate a solid angle range imaged on image sensors in four cameras in an image capturing apparatus according to a comparative example 1.

FIGS. 12A and 12B illustrate a superimposed portion among visual fields of the four cameras in the image capturing apparatus according to the comparative example 1.

FIGS. 13A to 13C illustrate a solid angle range imaged on image sensors in four cameras in an image capturing apparatus according to a comparative example 2.

FIGS. 14A and 14B illustrate a superimposed portion among visual fields of four cameras in the image capturing apparatus according to the comparative example 2.

FIG. 15 illustrates a relationship between the image sensor and the angle of view according to prior art 1.

FIG. 16 illustrates a relationship between the image sensor and the angle of view according to prior art 1.

FIG. 17 illustrates a visual field according to prior art 2.

FIG. 18 illustrates the image capturing apparatus according to the first embodiment that has fallen.

FIG. 19 illustrates an angle of view in a sensor long side direction in the image capturing apparatus according to the first embodiment.

FIG. 20 illustrates an all-round barrier.

FIG. 21 illustrates an angle of view in a sensor short side direction in the image capturing apparatus according to the first embodiment.

FIG. 22 illustrates an arrangement relationship between a close object and two cameras in the image capturing apparatus according to the first embodiment.

FIGS. 23A to 23C illustrate the positions of the protector in the image capturing apparatus according to the first embodiment.

FIG. 24 is an external view of an image capturing apparatus according to a second embodiment of the present invention.

FIG. 25 illustrates a relationship between a visual field in each camera and the position of the protector in the image capturing apparatus according to the first embodiment.

### DESCRIPTION OF THE EMBODIMENTS

Referring now to the accompanying drawings, a description will now be given of embodiments according to the present invention.

### First Embodiment

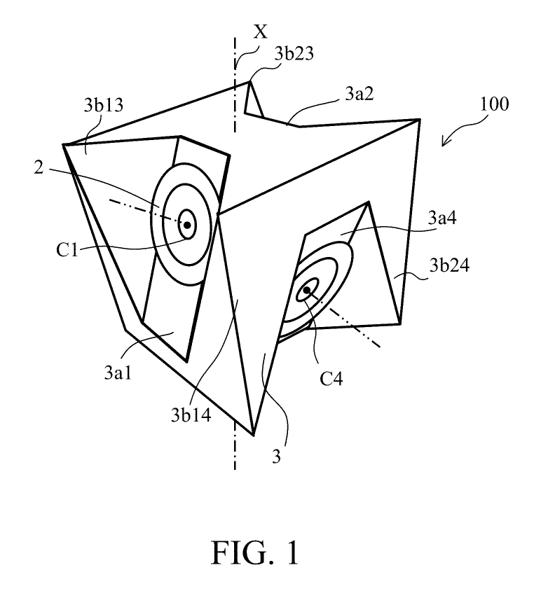

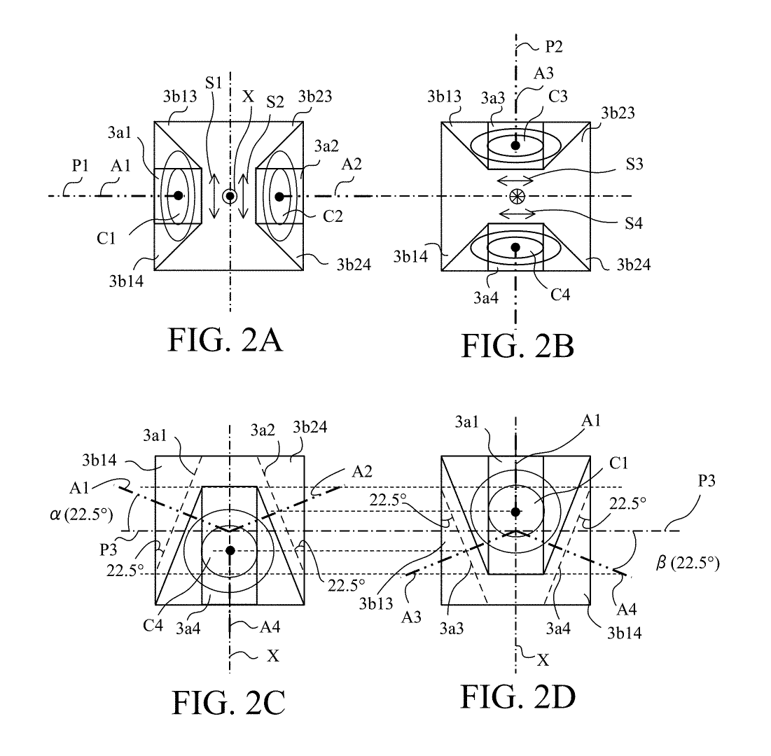

FIG. 1 illustrates an external appearance of an omnidirectional image capturing apparatus (simply referred to as an “image capturing apparatus” hereinafter) 100 according to a first embodiment of the present invention when viewed from an upper oblique direction. FIGS. 2A to 2D are a top view, a bottom view, a front view, and a side view of the image capturing apparatus 100, respectively.

The image capturing apparatus 100 includes four cameras, i.e., a first camera (a first image capturer) C1, a second camera (a second image capturer) C2, a third camera (a third image capturer) C3, and a fourth camera (a fourth image capturer) C4, a holding member 2, and an exterior member 3. The four cameras C1 to C4 are integrally held by the holding member 2. The exterior member 3 is fixed onto the holding member 2 so as to cover the four cameras C1 to C4 while exposing the front end lens surface (the optical surface closest to the object) of each camera and the surface of the holding member 2 around it.

Each of the cameras C1 to C4 includes a lens system (optical system) and an image sensor (image pickup element) having a rectangular image capturing surface orthogonal to an optical axis AXL in the lens system, and captures a directionally divided image in all directions.

Each of terms “orthogonal” and “parallel” in this embodiment is not limited to its strict meaning but may shift from the strict state within a range (e.g., within 5°) that permits the manufacturing error or does not impair the function the image capturing apparatus according to this embodiment.

The following description will simply refer to the first to fourth cameras C1 to C4 as cameras C1 to C4. In FIGS. 2A and 2B, a reference axis X is set to an axis perpendicular to the paper plane of the figure and parallel to the paper surface of the figure in FIGS. 2C and 2D.

As illustrated in FIG. 2A, the cameras C1 and C2 are arranged so that optical axes A1 and A2 are line-symmetric with respect to the reference axis X in a first plane P1 that includes the reference axis X and optical axes A1 and A2 as illustrated in FIG. 2A. The cameras C1 and C2 are arranged so that the first plane P1 is orthogonal to short side directions S1 and S2 of the image capturing surfaces in the cameras C1 and C2. The following description will refer to the short side direction of the image capturing surface as a sensor short side direction, and the long side direction of the image capturing surface as a sensor long side direction.

The cameras C3 and C4 are arranged so that their optical axes A3 and A4 are line-symmetric with respect to the reference axis X in a second plane P2 that includes the reference axis X and the optical axes A3 and A4. The cameras C3 and C4 are arranged so that the second plane P2 is orthogonal to sensor short side directions S3 and S4 of the cameras C3 and C4.

Each of terms “line symmetry” or “rotational symmetry” as used in this embodiment is not limited to the strict meaning but may shift from the strict state within a range that permits the manufacturing error or does not impair the function of the image capturing apparatus according to this embodiment.

The optical axes A1 and A2 of the cameras C1 and C2 located on a first side (the one side or the upper side in FIG. 2C) incline to a third plane P3 orthogonal to the reference axis X by the same first angle α. The optical axes A3 and A4 of the cameras C3 and C4 located on a second side (the other side or the lower side in FIG. 2C) opposite to the first side incline to the third plane P3 by the same second angle β. This embodiment set both α and β to 22.5°.

This embodiment does not limit “the same angle” to the strict meaning but can shift within a range that permits the manufacturing error or does not impair the function of the image capturing apparatus according to this embodiment.

Each of two lens exposing surfaces 3a1 and 3a2 formed as bevel planes exposes the front end lens surface of a corresponding one of the cameras C1 and C2 of the exterior member 3 inclines by 22.5° relative to the third plane P3 facing the first side (upper oblique side). Each of two lens exposing surfaces 3a3 and 3a4 formed as bevel planes exposes the front end lens surface of a corresponding one of the cameras C3 and C4 of the exterior member 3 inclines by 22.5° relative to the third plane P3 facing the second side (lower oblique side).

A protector 3b13 as a portion protruding to the object side from the vertices of the front end lens surfaces of the cameras C1 and C3 is provided between the lens exposing surfaces 3a1 and 3a3 in the exterior member 3 or between the visual fields of the cameras C1 and C3. The visual field will be described later. Similarly, a protector 3b23 protruding to the object side from the vertices of the front end lens surfaces of the cameras C2 and C3 is provided between the lens exposing surfaces 3a2 and 3a3 (or between the visual fields of the cameras C2 and C3). A protector 3b24 protruding to the object side from the vertices of the front end lens surfaces of the cameras C2 and C4 is provided between the lens exposing surfaces 3a2 and 3a4 (or between the visual fields of the cameras C2 and C4). A protector 3b14 protruding to the object side from the vertices of the front end lens surfaces of the cameras C1 and C4 is provided between the lens exposing surfaces 3a1 and 3a4 (or between the visual fields of the cameras C1 and C4).

No protector is provided to a portion of the exterior member 3 between the lens exposing surfaces 3a1 and 3a2 (or between the visual fields of the cameras C1 and C2) and between the lens exposing surfaces 3a3 and 3a4 (or between the visual fields of the cameras C3 and C4). Specific shapes of the protectors 3b13, 3b23, 3b24, and 3b14 will be described later.

As described above, the image capturing apparatus 100 according to this embodiment is configured rotationally symmetrical by 180° around the reference axis X.

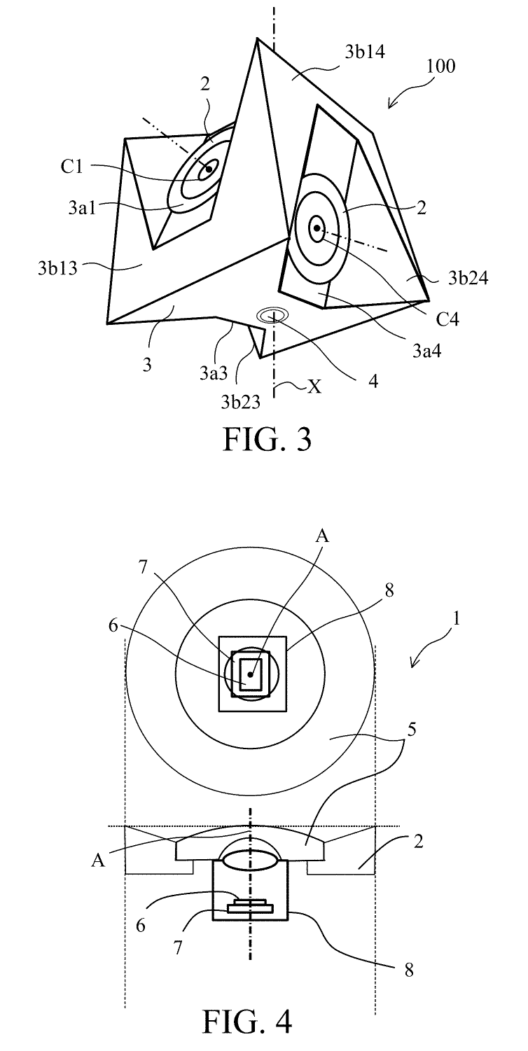

FIG. 3 illustrates the external appearance of the image capturing apparatus 100 when viewed from a lower oblique direction. A leg fixing screw hole portion 4 is provided to the bottom surface of the exterior member 3 along the reference axis X and used to fix the image capturing apparatus 100 onto a leg member by fastening a male screw provided on the leg member, such as an unillustrated single leg or a tripod.

FIG. 4 illustrates the same structure of the cameras C1 to C4. The camera 1 includes an image capturing lens (lens system) 5, an image sensor 6, a substrate 7, and a body 8. The image capturing lens 5 includes a concave meniscus lens having the largest diameter at the front end (closest to the object side) as a wide-angle lens that performs an f-θ projection. The image capturing lens 5 according to this embodiment has an angle of view 2ω of 135°.

The image sensor 6 is a photoelectric conversion element, such as a CCD sensor or a CMOS sensor, and is mounted on the substrate 7. The image capturing surface of the image sensor 6 is formed in a rectangular shape with a ratio of the short side length to the long side length is 2:3. The body 8 holds the substrate 7 mounted with the image sensor 6 and the image capturing lens 5. The optical axis A in the image capturing lens 5 passes through the center of the image capturing surface of the image sensor 6 and is orthogonal to the image capturing surface.

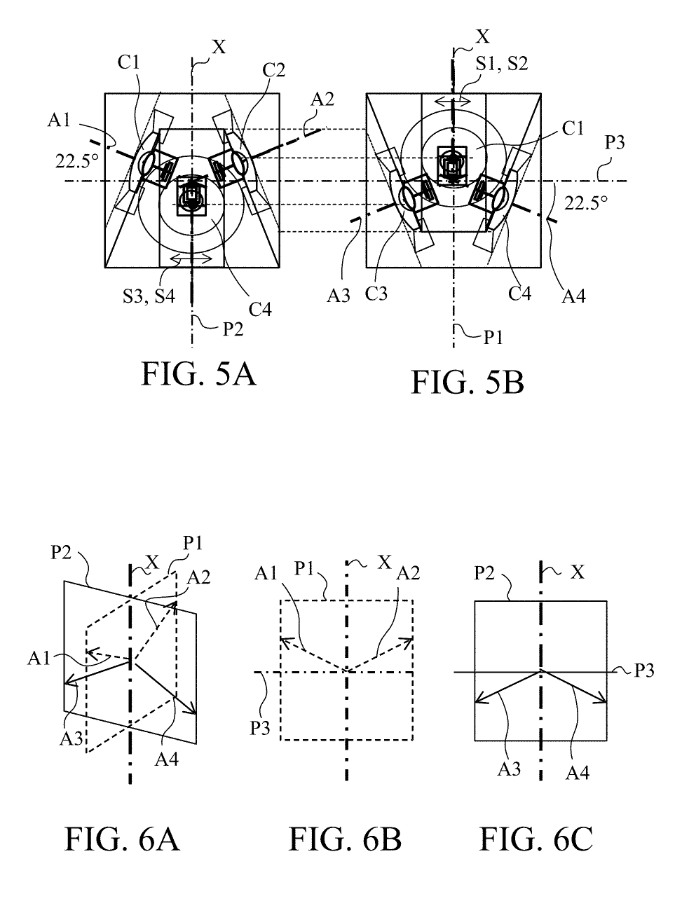

FIGS. 5A and 5B illustrate the arrangement of the four cameras C1 to C4. FIG. 5A illustrates the arrangement viewed from the front, and FIG. 5B illustrates the arrangement viewed from the side. As illustrated in FIG. 5A, the two or left and right cameras C1 and C2 are arranged so that their optical axes A1 and A2 obliquely upwardly extend. FIG. 6B illustrates a relationship between the optical axes A1 and A2 and the reference axis X. The optical axes A1 and A2 and the reference axis X are included in the first plane P1 as the same plane. The optical axes A1 and A2 are arranged line-symmetrically with respect to the reference axis X and incline upwardly by 22.5° to the third plane P3 orthogonal to the reference axis X. As illustrated in FIG. 5B, the image sensors 6 in the cameras C1 and C2 are arranged such that their short side directions S1 and S2 are perpendicular to the first plane P1.

On the other hand, as illustrated in FIG. 5B, the two or front and rear cameras C3 and C4 are arranged so that their optical axes A3 and A4 obliquely downwardly extend. FIG. 6C illustrates a relationship between the optical axes A3 and A4 and the reference axis X. The optical axes A3 and A4 and the reference axis X are included in the second plane P2 as the same plane. The optical axes A3 and A4 are arranged line-symmetrically with respect to the reference axis X and incline to the third plane P3 downwardly by 22.5°. As illustrated in FIG. 6A, the first plane P1 and the second plane P2 are orthogonal to each other on the reference axis X. As illustrated in FIG. 5A, the image sensors 6 of the cameras C3 and C4 are arranged such that their short side directions S3 and S4 are orthogonal to the second plane P2.

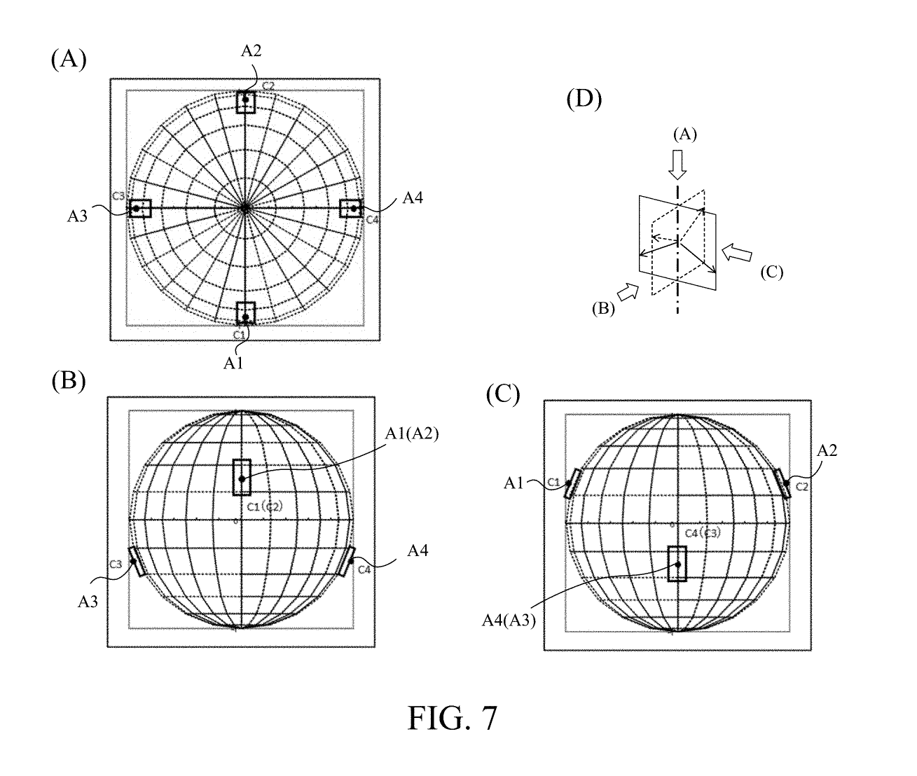

FIG. 7(A) to (D) spherically illustrates all directions. Now assume that an axis corresponding to the reference axis X is called an earth axis of the sphere, a plane including a great circle that passes through the center of the sphere and is orthogonal to the earth axis is called an equatorial plane, and an outer circumference of the great circle is called the equator. The top end of the sphere is called a north pole and the bottom end is called the south pole. Angles of an east longitude and a west longitude are expressed based on a meridian intersecting the optical axis A1 of the camera C1 as a reference (0°) among the plurality of meridians drawn based on the sphere, and angles of the north latitude and the south latitude are expressed based on the equator as a reference (0°).

As illustrated in FIG. 7(D), FIG. 7(A) illustrates a sphere viewed from the top (north pole side), FIG. 7(B) illustrates a sphere viewed from the side (+90° direction), and FIG. 7(C) illustrates a sphere viewed from the front (0° direction), respectively. Illustrated on the sphere are intersections with the optical axes A1 to A4 in the cameras C1 to C4 and the directions of the image sensors 6 (in which the short side and the long side of 2:3 extend).

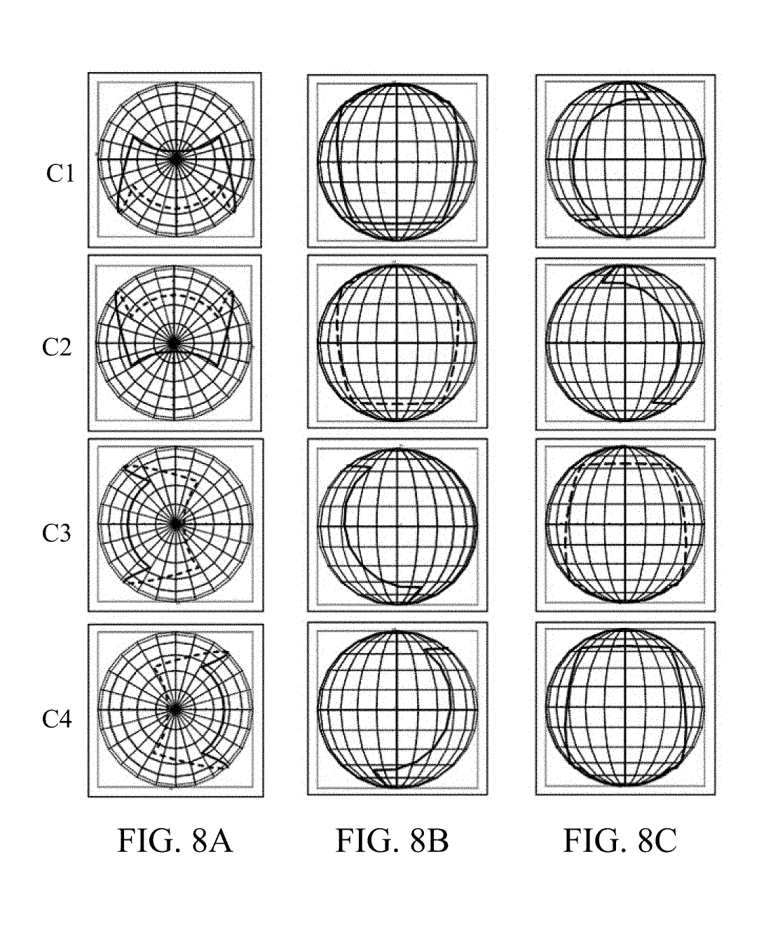

FIGS. 8A to 8C illustrate the visual fields of the cameras C1 to C4 on the same sphere as in FIG. 7 or the angular ranges of the object imaged on the image sensors 6. The image capturing lenses 5 in the cameras C1 to C4 have focal lengths of 24 mm in the sensor short side direction and 36 mm in the sensor long side direction.

The visual field of the camera C1 includes a north pole at the top, and extends to the bottom around 45° S (south latitude) and from around 45° E (east longitude) to around 45° W (west longitude) via 0° E (W) on the equator. As illustrated in FIG. 8A, the top of the visual field of the camera C1 extends from around 120° E to around 120° W via 0° E (W) around the north pole.

The visual field of the camera C2 is line-symmetric with respect to the image capturing range of the camera C1 and the earth axis or surface-symmetrical with respect to a plane including the earth axis and meridians of 90° E and 90° W. The top of the visual field of the camera C2 includes the north pole, and its lower part extends to around 45° S and from the 135° E to 135° W via the 180° E (W) on the equator. The top of the visual field of the camera C2 extends from around 60° E to around 60° W via 180° E (W) around the north pole.

The lower part of the visual field of the camera C3 includes a south pole, and the upper part extends to around 45° N (north latitude) and from around 45° W to 135° W via 90° W on the equator. The lower part of the visual field of the camera C3 extends from around 30° E to around 150° E via 90° W around the south pole point.

The visual field of the camera C4 has a range line-symmetrical with respect to the image capturing range of the camera C3 and the earth axis or surface-symmetrical with respect to a plane including the earth axis and the meridian of 0° E (W). The lower part of the visual field of the camera C4 includes a south pole point, and the upper part extends to around 45° N and from 45° E to 135° E via 90° E on the equator. The lower part of the visual field of the camera C4 extends from around 30° W to around 150° W via 90° W around the south pole.

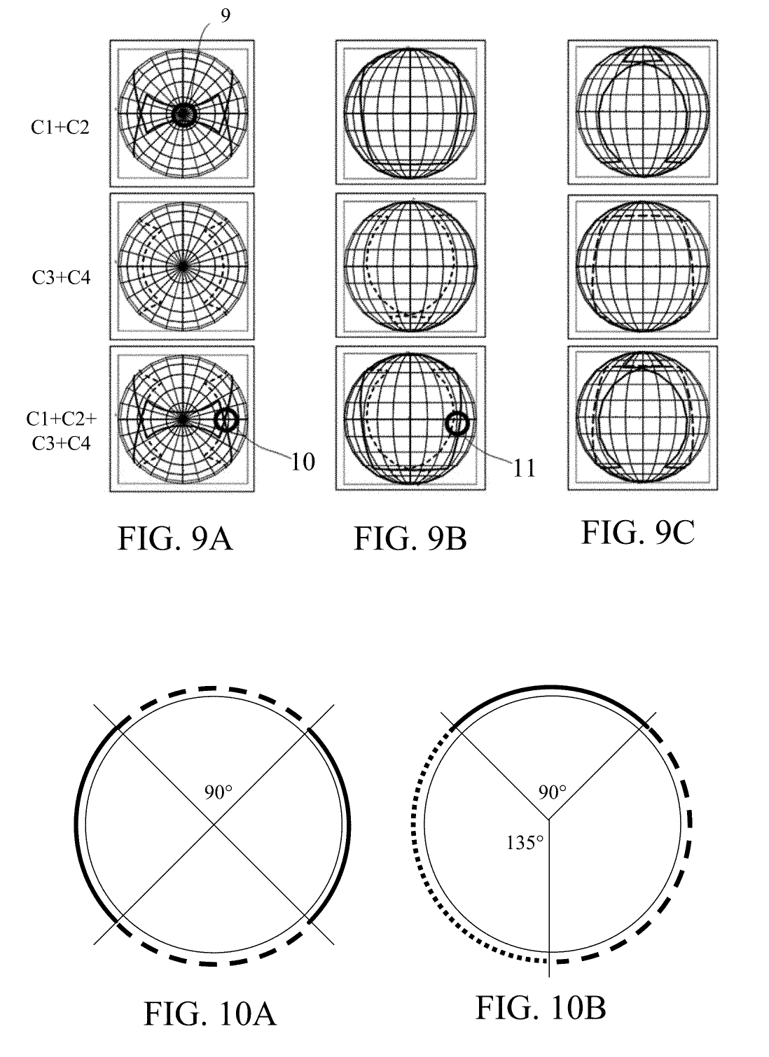

FIGS. 9A to 9C illustrate superimposed visual fields of the cameras C1 to C4 illustrated in FIGS. 8A to 8C. The visual field of the camera C1 and the visual field of the camera C2 illustrated by C1+C2 in the figure are superimposed on each other near the north pole point enclosed by a bold circle 9 in FIG. 9A. Each of these visual fields covers a range from around 45° E to around 45° W on the equator, a range from around 135° E to around 135° W on the equator, and a range up to around 45° S.

The visual field of the camera C3 and the visual field of the camera C4 illustrated by C3+C4 superimpose on each other around the south pole point. Each of these visual fields covers a range from around 45° W to around 135° W on the equator, a range from around 45° E to around 135° E on the equator, and a range up to around 45° N.

The upper end line of the visual field of the camera C4 contacts the intersection between the visual field of the camera C1 and the visual field of the camera C2 in a region indicated by a bold circle 10 in FIG. 9A in C1+C2+C3+C4 illustrating the superimposed visual fields of the four cameras C1 to C4. Thereby, the superimposed visual fields of the cameras C1 to C3 can be minimized. A bold circle 11 in FIG. 9B illustrates the superimposed visual fields of the cameras C1 and C4 on the equator. These visual fields superimpose on each other by several degrees. Thus, the visual fields of the cameras C1 to C3 may be superimposed on each other at three areas indicated by the bold circles 9 to 11.

The portions indicated by the bold circles 9 and 11 need a superimposition area to some extent, in jointing images as described later. Since the visual fields of the cameras C1, C2, and C4 are superimposed on the point in the bold circle 10, the superimposed area may be the minimum necessary. This also applies to the superimposed visual fields of the cameras C1, C2, and C4. In order to arrange the three portions in a well-balanced manner, a ratio of the short side length to the long side length on the image capturing surface in the image sensor 6 may be 2:3, and an angle between the equatorial plane and each camera may be around 22.5°.

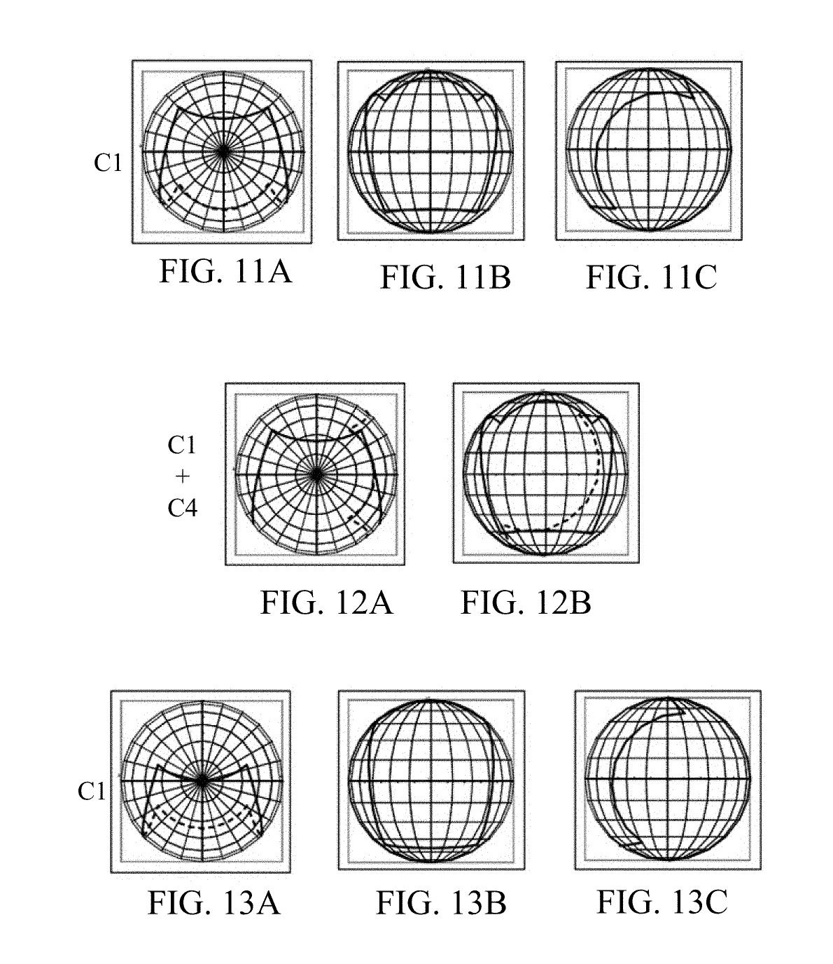

The reasons will be explained below. FIGS. 10A and 10B illustrate the visual field allocation (in other words, effective angle of view, simply referred to as an “angle of view” hereinafter) of the cameras C1 to C4 on the equatorial plane and the meridional direction. The angle of view corresponding to the sensor short side direction of each camera on the equatorial plane has a minimum angle of view of 90° obtained by quadrisecting 360°, as illustrated in FIG. 10A. In the meridional direction, as illustrated in FIG. 10B, one extreme side of the north pole and the south pole has an angle of view corresponding to the sensor short side direction, and the other extreme side has an angle of view corresponding to the sensor long side direction, and these two cover 360°. Thus, 135° is required for the angle of view corresponding to the sensor long side direction. In minimizing the superimposed visual fields, the ratio of the angle of view corresponding to the sensor short side direction to the angle of view corresponding to the sensor long side direction is 2:3 and this ratio can maximize the utilization efficiency of the image sensor 6.

The four images acquired through image capturing by the four cameras C1 to C4 are combined (combined) through image processing. Then, a superimposed portion is necessary to some extent among the four images. In order to increase the angle of the superimposed portion, it is necessary to widen the angle of view of the image capturing lens 5 to the wide-angle side. However, the combined image never exceeds the range of 360°, and the total of angles of view used as the combined image among the images acquired by the respective cameras C1 to C4 is 360°. In other words, even if there is a superimposed portion, the ratio of 2:3 maximizes the utilization efficiency of the image sensor 6 since the angle of view of each camera is defined at the boundary between the combined images.

The image capturing apparatus disclosed in JP 2016-118742 requires the image capturing lens in each camera to be an all-around fisheye lens so as to capture an omnidirectional image with two image sensors. A general image sensor has a rectangular image capturing surface with a typical aspect ratio of 3:4, 2:3, or 9:16. Even when the image sensor having the aspect ratio of 3:4 closest to 1:1 among them is used for the image capturing apparatus disclosed in JP 2016-118742, the effective image capturing area of 58.9% is actually used to capture an image in the image capturing surface, as illustrated in FIG. 15, and the utilization efficiency is low.

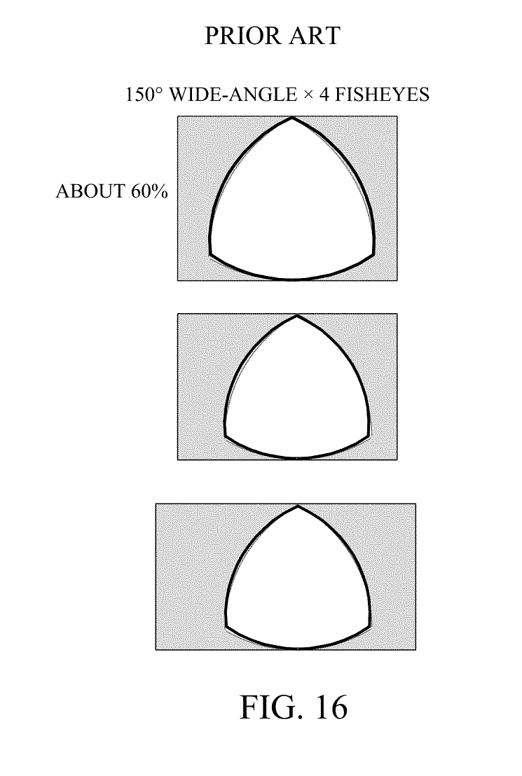

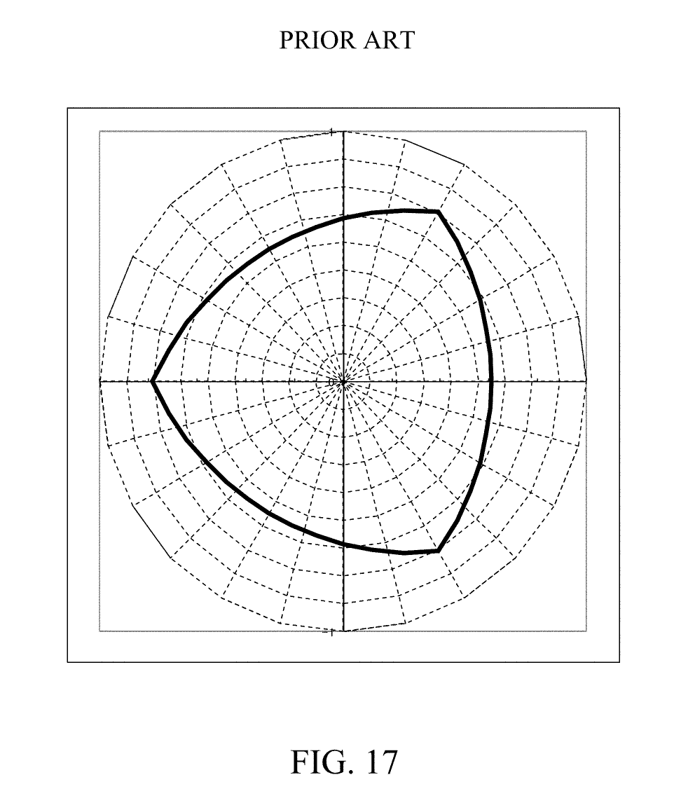

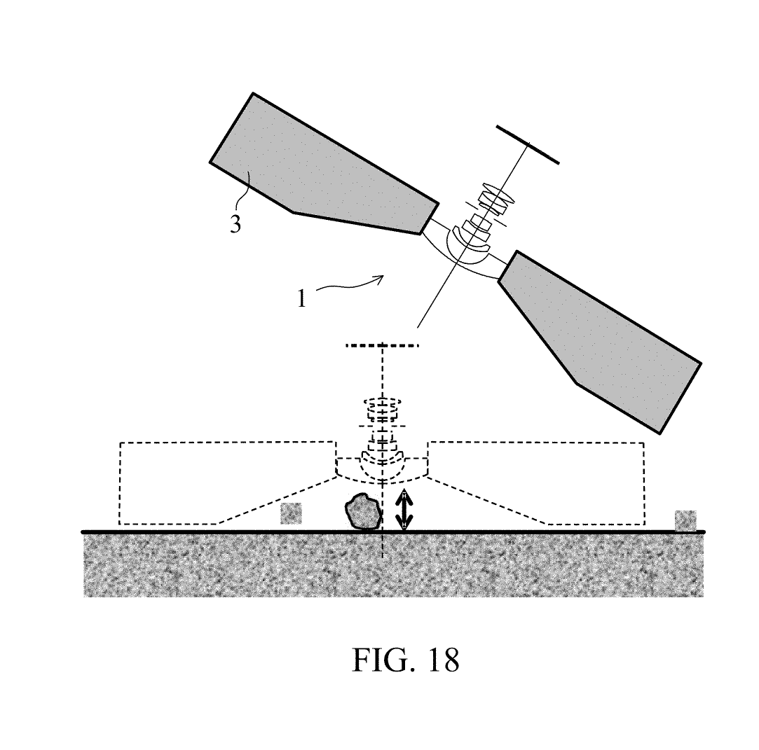

In the image capturing apparatus disclosed in U.S. Pat. No. 8,902,322, the four cameras face the four highly symmetrical vertexes in the regular tetrahedron and thus it appears that equally dividing all directions in capturing an image is efficient. However, when four image sensors having rectangular image capturing surfaces of the same shapes are used, the utilization efficiency of the image sensors is low. FIG. 16 illustrates an effective image capturing area in one image sensor in the image capturing apparatus disclosed in U.S. Pat. No. 8,902,322. Since the four image sensors are arranged at mutually symmetrical positions, the visual field allocated to one image sensor corresponds to an angular range when one regular triangle plane is viewed from the center of the regular tetrahedron. FIG. 17 illustrates an isometric projection of the angular range on the image capturing surface on the image sensor. In this case, as illustrated in FIG. 16, the effective image capturing area is as low as about 60% of the area of the image capturing surface in the image sensor.

FIG. 18 illustrates the image capturing apparatus 100 falling down on the ground (asphalt pavement surface). The image capturing apparatus 100 is often fixed and lifted on the ground with a pod member such as a monopod. The general asphalt pavement uses crushed stone as the aggregate, and its particle diameter is 13 to 15 mm. Pebbles on the pavement surface are mainly caused by this aggregate.

As illustrated, the front end lens surface of the camera 1 is retracted to the rear (opposite to the object) from the surrounding exterior member 3, and thereby protected from hitting of the pebbles or the like on the pavement surface. Based on the particle size of the aggregate, it is necessary to retract the front lens surface from the exterior member 3 by at least 10 mm, or by 15 mm or more, or by 17 mm or more.

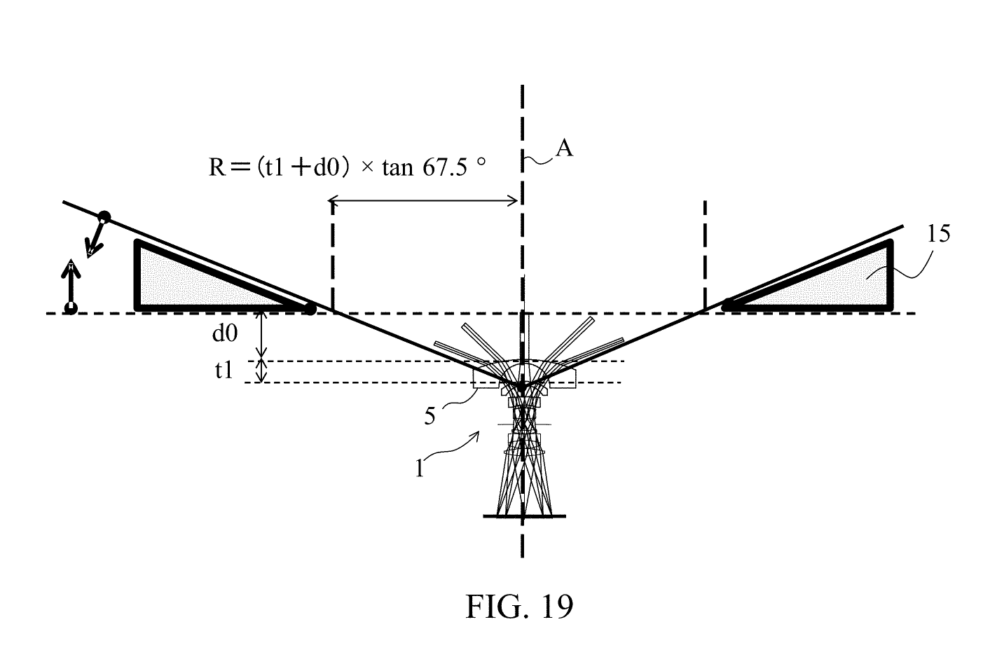

FIG. 19 illustrates a region where the protector is to be provided to the exterior member 3 in the sensor long side direction. A half field angle ω is necessary on one side of the optical axis A from the entrance pupil position of the image capturing lens 5, where 2ω is a total angle of view in the sensor long side direction in the camera 1. FIG. 19 illustrates the angle of view 2ω of 135° in the sensor long side direction.

When there is a mechanical member at least within this angle of view, a necessary light flux is shielded by the mechanical member. In order to retract the vertex of the front end lens surface from the exterior member 3 by d0 without shielding the necessary light flux, a protector as a mechanical member is necessary in a region enclosed by a bold line in the drawing.

The shortest distance R from the optical axis A in the region in which the protector can be disposed is given by the following expression (1).

R=(t1+d0)×tan 67.5° (1)

For example, where the entrance pupil position t1 of the image capturing lens 5 is 7 mm and a retraction amount of the vertex of the front end lens surface is 15 mm, the shortest distance R from the optical axis A in the area in which the barrier or protector can be disposed is 53.1 mm.

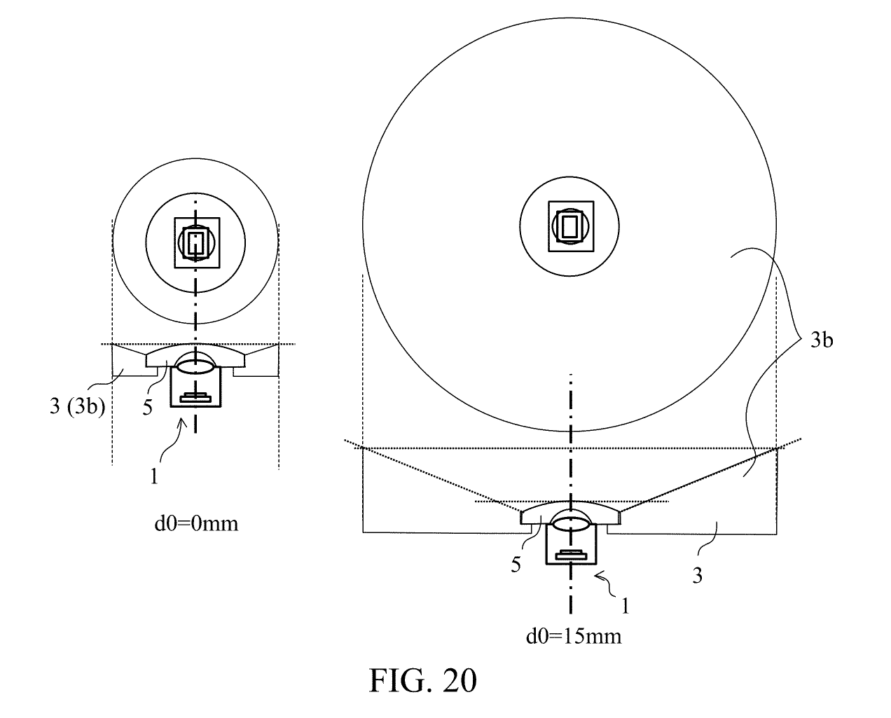

FIG. 20 illustrates a protector 3b provided over the entire circumference of the front end lens surface. FIG. 20 illustrates a diameter difference of the protector 3b when the protector 3b is provided at substantially the same height as the vertex of the front end lens surface so that d0 is equal to 0 mm and when the protector 3b is provided so that d0 is equal to 15 mm. Where the field angle 2ωL is 135°, the former diameter is 33.8 mm and the latter diameter is φ106.2 mm. Hence, if the protector is provided over the entire circumference of the front end lens surface, the image capturing apparatus 100 becomes larger due to the increased diameter.

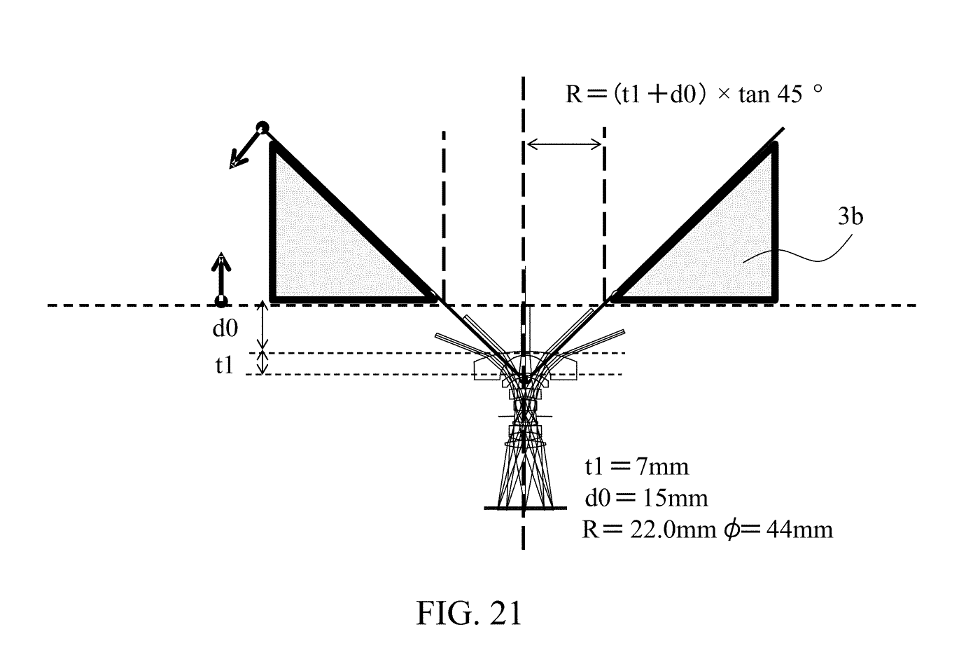

FIG. 21 illustrates a region where the protector is to be provided to the exterior member 3 in the sensor short side direction. A half angle of view ω is necessary on one side of the optical axis A from the position of the entrance pupil in the image capturing lens 5, where 2ωS is a field angle in the sensor short side direction of the camera 1. FIG. 19 illustrates the angle of view 2ωL of 135° in the sensor long side direction.

FIG. 21 illustrates a region where the protector is to be provided to the exterior member 3. Due to the calculation similar to the sensor long side direction which sets the total angle of view 2ωS of the camera 1 in the sensor short side direction to 90°, the protector has a diameter of φ14 mm when the protector 3b is provided at substantially the same height as the vertex of the front end lens surface so that d0 is equal to 0 mm. On the other hand, the protector has a diameter of φ44 mm so that d0 is equal to 15 mm. Hence, the image capturing apparatus 100 can be prevented from becoming larger by providing the protector 3b in the sensor short side direction.

In using a wide-angle lens, a flare cutting hood may be used so as to prevent unnecessary light from entering the camera. Then, the image capturing apparatus 100 that arranges the four cameras adjacent to one another has a problem of mechanical interference between the protectors provided between the cameras and the hoods. It is thus necessary to place the protector away from each camera.

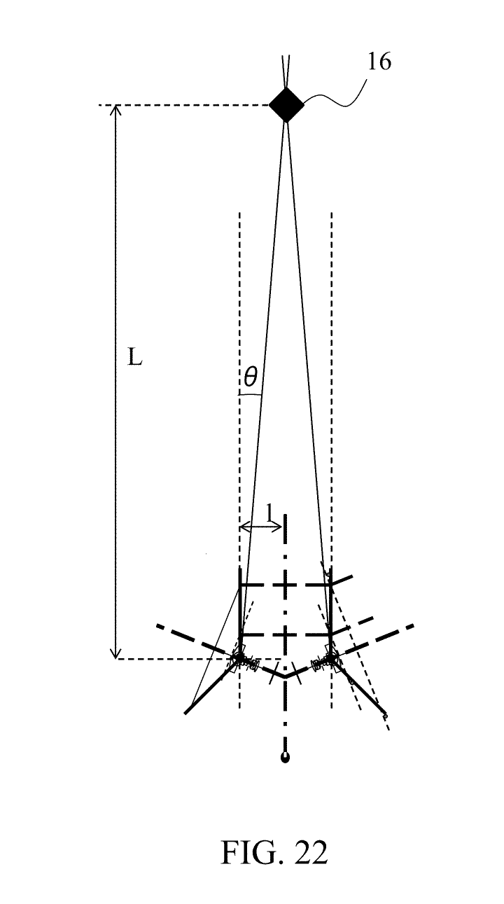

While the above description assumes the infinite object distance, an actual product needs to consider a close or shot-distance object. More specifically, it is necessary to consider the close object with an object distance of 1 m or less, and to combine images obtained by imaging the close object with at least the object distance of about 50 cm using two cameras. As illustrated in FIG. 22, where the distance is 10 cm between the entrance pupil positions in the image capturing lenses in the two adjacent cameras, the half angle of view of the image capturing lens requires a margin amount θ of about 5.7° or more in order to combine images obtained by imaging a close object 16 having an object distance L of 50 cm. As a result, it is necessary to dispose the protector at a more distant position, and the image capturing apparatus 100 becomes larger.

Where the intervals between the entrance pupil positions in the image capturing lenses in the four cameras are all the same, the margin amount of the angle of view determined by the shortest image capturing distance is about 5.7° or higher regardless of the direction, such as the sensor short side direction and the sensor long side direction. However, when the angle of view is widened by the same margin amount of 5.7°, a change amount in the size of the protector in the sensor long side direction is about twice as large as that in the sensor short side direction. In order to minimize the size of the image capturing apparatus 100 including the protector, it is necessary to provide a protector only between the visual fields in the sensor short side direction as in this embodiment, and it is effective not to provide a protector between the visual fields in the sensor long side direction.

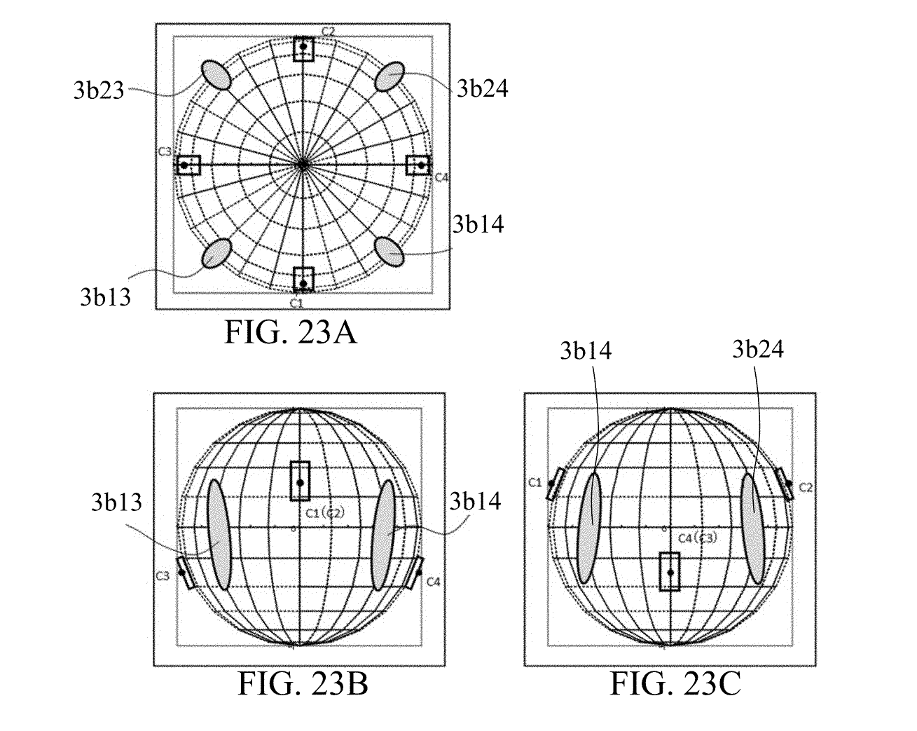

FIGS. 23A to 23C illustrate positions on the sphere illustrated in FIG. 7 of the protectors 3b13, 3b23, 3b24, and 3b14 illustrated in FIGS. 1 to 3.

The protectors 3b13, 3b23, 3b24, and 3b14 are respectively disposed between the cameras C1 and C3, between the cameras C2 and C3, between the cameras C2 and C4, and between the cameras C1 and C4 in the sensor short side direction so as to cross the equator in the vertical direction. The protectors 3b13, 3b23, 3b24, and 3b14 are arranged at the positions such that they do not appear in the respective cameras (so that the light beams toward the respective cameras are not shielded). On the other hand, no protector is arranged around the north pole between the cameras C1 and C2 in the sensor long side direction, and around the south pole between the cameras C3 and C4.

More specifically, the four protectors 3b13, 3b23, 3b24, and 3b14 are provided by cutting off four grooves from a cube and by forming the exterior member 3 in a shape with the lens exposing surfaces 3a1, 3a2, 3a3, and 3a4 as bottom surfaces described with reference to FIGS. 1 to 3.

FIG. 25 illustrates a relationship between visual fields V1 to V4 of the cameras C1 to C4 and the protectors 3b13, 3b23, 3b24 and 3b14. The visual fields V1 to V4 intersect (superimpose) at positions distant from the corresponding cameras C1 to C4. The protector 3b13 is provided at a position closer to the cameras C1 and C3 than a position where the visual field V1 of the camera C1 and the visual field V3 of the camera C 3 intersect each other, or between the visual field V1 and the visual field V3. Similarly, the protector 3b23 is provided between the visual field V2 of the camera C2 and the visual field V3 of the camera C3, and the protector 3b24 is provided between the visual field V2 of the camera C2 and the visual field V4 of the camera C4. The protector 3b14 is provided between the visual field V1 of the camera C1 and the visual field V4 of the camera C4.

The shape of the exterior member 3 described above forms an opening of 180° to each camera in the sensor long side direction. In the sensor short side direction, a portion protruding to the object side from the vertex of the front end lens surface of each camera serves as the protectors 3b13, 3b23, 3b24, and 3b14.

The exterior member 3 having such protectors 3b13, 3b23, 3b24, and 3b14 separates the vertex of the front end lens surface from the ground by a sufficient height, even if the image sensor 100 is placed on the ground (even if the image capturing apparatus 100 falls down) so that any one of cameras faces down. Any pebbles or the like on the ground never contact the front end lens surface or are prevented from scratching the front end lens surface.

The following conditions are necessary to prevent the image capturing light flux from being shielded by the protector provided in the short side direction.

R≥(t1+d0)×tan 45°

Since the required minimum angle of view in the short side direction is 90°, it is necessary to provide the protector so as not to shield at least the light flux.

The angle of view in each lens system needs to satisfy the following two conditions.

2ωS×4≥360°

On the equatorial plane, the field angle in the sensor short side direction of the four cameras needs to cover the entire circumference angle of view of 360° and thus satisfy the above conditions.

2ωS×2+2ωL≥360°

On the other hand, the angle of view in the sensor long side direction of the two cameras and the angle of view in the sensor short side direction of one camera need to cover 360° in the meridional direction. The minimum angles of view of each camera that satisfies these conditions are 2ωL of 135° and 2ωS of 90°. Then, 2ωS:2ωL=2:3 is satisfied. Since the mutually superimposed portions are actually required in combining images, each angle of view becomes accordingly larger. It is ideal to increase the angle of view while the ratio of the angle of view in the sensor short side direction to the angle of view in the sensor long side direction is maintained to be 2:3. In changing this ratio, it is better to increase the margin in the sensor short side direction.

The angle of view in the sensor long side direction may be 1.8 times as large as the angle of view in the sensor short side or less as in the following condition, and the angle of view in the sensor long side direction larger than this value optically undesirably wastes the margin and the angle of view of the lens system.

2ωL≤1.8×2ωS

In other words, the specification of the optical system can be made simpler since the angle of view 2ωD in the diagonal direction of the image sensor is equal to or smaller than the diagonal length of the rectangle formed by the short side (2ωS) and the long side (2ωL). Since the angle of view in the sensor long side direction is necessary, the lower limit value is 2ωL but the size of the entire optical system can be suppressed by reducing the margin of the angle of view in the diagonal direction.

2ωD≤√(2ωS²+2ωL²)

Ideally, the ratio of the angle of view in the sensor long side direction to the angle of view in the sensor short side direction is about 1.5 as described above. The margin of the angle of view may be provided to the sensor short side direction rather than the sensor long side direction, and the condition is set wider to the image sensor with a lower aspect ratio. The image sensor with the low aspect ratio has an increased margin of the angle of view in the sensor short side direction and thus is advantageous in combining images in the equator direction.

In the general image capturing, a distant object to be addressed is often located in the horizontal direction. A wider margin may be advantageous in joining (combining) such object images. Hence, an image sensor having an aspect ratio satisfying the following condition, in particular, an image sensor having an aspect ratio as low as about the lower limit value may be used.

1.3≤2ωL/2ωS≤1.6

### Second Embodiment

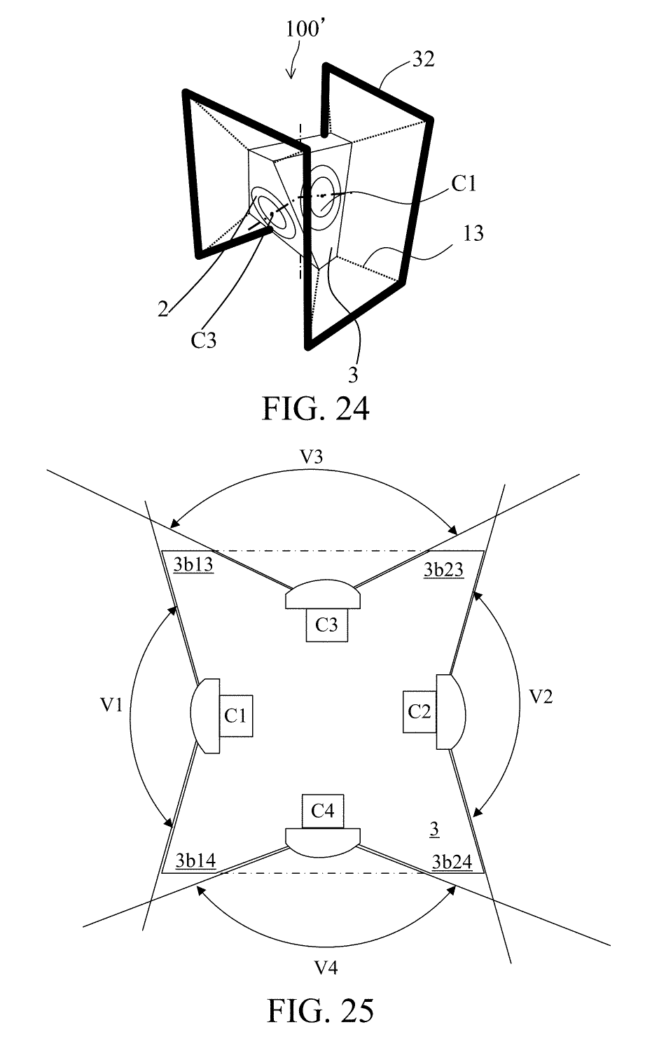

FIG. 24 illustrates an image capturing apparatus 100′ according to a second embodiment of the present invention. The image capturing apparatus 100′ according to this embodiment also has four cameras, and the arrangement of these four cameras (the optical axis of the image capturing lens and the orientation of the image sensor) and the visual field are the same as those in the first embodiment.

In this embodiment, a first exterior member 31 has the four lens exposing surfaces corresponding to the lens exposing surfaces 3a1, 3a2, 3a3, and 3a4 illustrated in FIGS. 1 to 3 according to the first embodiment and is fixed onto a holding member 2 that holds the cameras C1 to C4. The first exterior member 31 is also fixed onto a frame-shaped second exterior member 32 via a plurality of supporting members 13 such as wires. The second exterior member 32 serves as a protector.

The second exterior member 32 is a frame structured member made of lightweight metal, such as aluminum or magnesium alloy, plastic, and carbon fiber, and has eight sides out of twelve sides of a cube written in a single stroke. Eight vertices of the second exterior member 32 are connected to the first exterior component 31 by the supporting member 13. The supporting member 13 is made of metal wire, rubber wire, or the like.

When the image capturing apparatus 100′ falls over, the second exterior member 32 serving as the protector separate the vertex of the front end lens surface from the ground by a sufficient height even if any of the cameras face down. Hence, any pebbles or the like on the ground never contact the front end lens surface or are prevented from scratching the front end lens surface. In addition, the damages to the cameras C1 to C4 can be reduced since the second exterior member 32 and the supporting member 13 are elastically deformed.

Since the supporting member 13 is detachable from the first and second exterior members 31 and 32, the maintenance of the cameras C1 to C4 by the user can be facilitated.

### Comparative Example 1

A comparative example 1 will be described. In this comparative example, angles of the optical axes in the four cameras relative to the equatorial plane (third plane) are 35.26° in a vertex direction of the regular tetrahedron. This comparative example also has the ratio of the short side length to the long side length of the image sensor of 2:3. The image capturing lens in each camera has a focal length off of 13.0 mm.

FIGS. 11A to 11C illustrate the visual field of the camera C1 similarly to FIGS. 8A to 8C. FIGS. 12A and 12B illustrate the superimposed imaging ranges of the cameras C1 and C4. This comparative example has a quite large superimposed area between the visual fields of the cameras C1 and C2 around the north pole point, and also a large superimposed area between the visual fields of the cameras C1 and C4 on the equator. Thereby, the utilization efficiency of the image sensor is considerably lower than those of the first and second embodiments.

### Comparative Example 2

A comparative example 2 will be described. In this comparative example, angles of the optical axes in the four cameras relative to the equatorial plane (third plane) are 18°. In addition, this comparative example also has a ratio of the short side length to the long side length of the image sensor of 2:3. The image capturing lens in each camera has a focal length f of 14.2 mm.

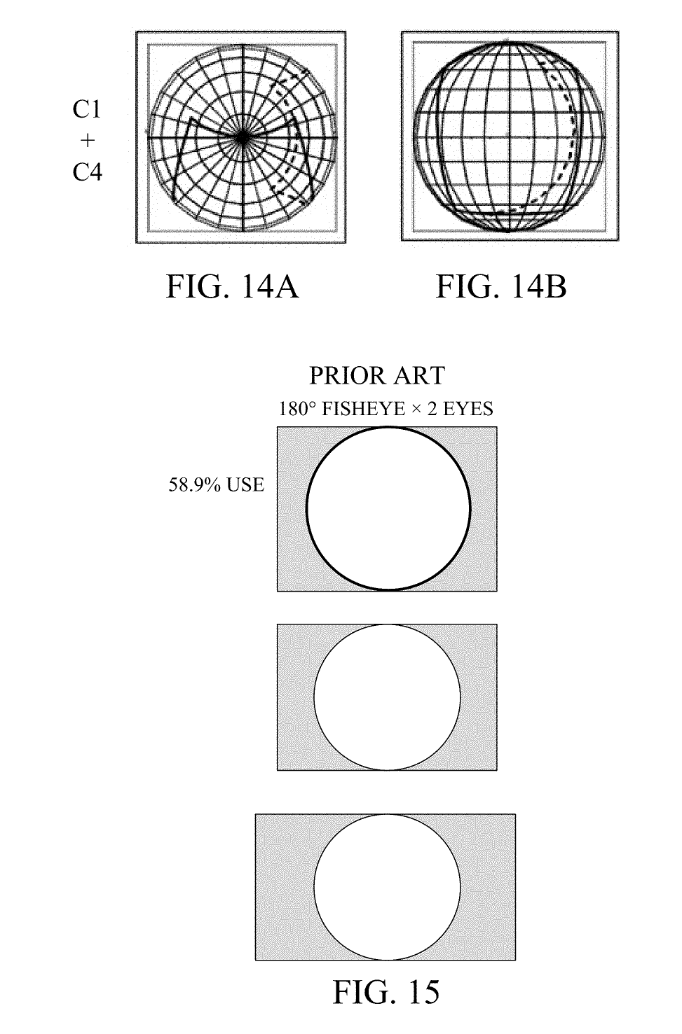

FIGS. 13A to 13C illustrate the visual field of the camera C1 similarly to FIGS. 8A to 8C. FIGS. 14A and 14B illustrate the superimposed imaging ranges of the cameras C1 and C4. This comparative example has a considerably small superimposed area between the visual fields of the cameras C1 and C4 on the equator, but undesirably has a superimposed point between the visual fields of the cameras C1 and C2 around the north pole point.

Each of the above embodiments provide the protector at a proper position in the exterior member and can realize an omnidirectional image capturing apparatus in which the optical surface of each image capturing apparatus is less likely to get scratched.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-250268, filed on Dec. 26, 2017, which is hereby incorporated by reference herein in its entirety.

What is claimed is:

1. An image capturing apparatus comprising first, second, third, and fourth image capturers each including an optical system and an image sensor having a rectangular image capturing surface orthogonal to an optical axis in the optical system,
wherein first and second optical axes in the first and second image capturers are line-symmetrical with respect to a reference axis in a first plane, and a short side direction of the image capturing surface in each of the first and second image capturers is orthogonal to the first plane,
wherein third and fourth optical axes in the third and fourth image capturers are line-symmetric with respect to the reference axis in a second plane orthogonal to the first plane, and a short side direction of the image capturing surface of each of the third and fourth image capturers is orthogonal to the second plane,
wherein the first and second optical axes incline to a third plane orthogonal to the reference axis on one side of the third plane,
wherein the third and fourth optical axes incline to the third plane on the other side of the third plane,
wherein a protector is a portion projecting to an object side from a vertex of an optical surface closest to the object side of each of the two optical systems between visual fields of the two image capturers among the first to fourth image capturers,
wherein the protector is provided between visual fields of the first and third image capturers, between visual fields of the third and second image capturers, between visual fields of the second and fourth image capturers, and between visual fields of the first and fourth image capturer, and
wherein no protector is provided between the visual fields of the first and second image capturers and between the visual fields of the third and fourth image capturers.

2. The image capturing apparatus according to claim 1, wherein the first and second optical axes incline to the third plane by the same first angle, and the third and fourth optical axes incline to the third plane by the same second angle.

3. The image capturing apparatus according to claim 1, wherein the following condition is satisfied in the first to fourth image capturers:
R≥(t1+d0)×tan 45°
where d0 [mm] is a distance from the vertex of the optical surface to the protector, R [mm] is a distance from the optical axis to the protector in the short side direction, and t1 [mm] is a distance from an entrance pupil in the optical system to the vertex of the optical surface.

4. The image capturing apparatus according to claim 1, wherein a distance from the vertex of the optical surface to the protector is 10 mm or less in the first to fourth image capturers.

5. The image capturing apparatus according to claim 2, wherein the following conditions are satisfied:
20°≤α≤26°
20°≤β≤26°
where α is the first angle and β is the second angle.

6. The image capturing apparatus according to claim 1, wherein the following conditions are satisfied in the first to fourth image capturers:
2ωS×4≥360°
2ωS×2+2ωL≥360°
where 2ωL is an effective angle of view in the long side direction on the image capturing surface, and 2ωS is an effective angle of view in the short side direction on the image capturing surface.

7. The image capturing apparatus according to claim 1, wherein the following conditions are satisfied in the first to fourth image capturers:
2ωL≤1.8×2ωS
2ωD≤√(2ωS²+2ωL²)
where 2ωL is an effective angle of view in the long side direction on the image capturing surface, and 2ωD is an effective angle of view in a diagonal direction on the image capturing surface.

8. The image capturing apparatus according to claim 1, wherein the following condition is satisfied in the first to fourth image capturers:
1.3≤2ωL/2ωS≤1.6
where 2ωL is an effective angle of view in the long side direction on the image capturing surface, and 2ωS is an effective angle of view in the short side direction on the image capturing surface.
